(19) United States
(12) Patent Application Publication
(10) Pub. No.: US 2005/0265427 A1
(43) Pub. Date: Dec. 1, 2005

(54) Up converted PRN generator

(76) Inventor: Linley F. Gumm, Beaverton, OR (US)

Correspondence Address: TEKTRONIX, INC.;Francis I. Gray, MS 50-LAW, P.O. BOX 500, Beaverton, OR, 97077, US

(21) Appl. No.: 10/857,001

(22) Filed: May 28, 2004

(51) Int. Cl. H04B 1/69

(52) U.S. Cl. 375/130

(57) ABSTRACT

An up converted PRN generator modulates a PRN sequence logically onto a carrier signal to produce a wideband signal having a flat spectrum in a frequency range well above zero. A carrier frequency at an integer multiple of a clock signal and the output of a PRN generator clocked by the clock signal are input to an exclusive OR gate to produce the up converted PRN sequence having a wide, flat bandwidth about the carrier frequency that is twice that of a baseband PRN sequence.

### BACKGROUND OF THE INVENTION

The present invention relates to radio frequency (RF) test and measurement equipment or other RF equipment, and more particularly to up converting the spectrum of a pseudo-random number (PRN) generator for calibrating such test and measurement equipment or for operational use in other RF equipment.

Equipment intended for making precision measurements of complexly modulated RF signals typically use corrections based on the measurement of internally generated calibration signals to achieve the desired accuracy. By this means residual errors present in any analog system may be measured and corrected. Other RF equipment makes use of PRN sequences as part of a communication system or to measure the distance between objects.

A typical signal used for the calibration process is obtained from a PRN generator. A generator of this type, clocked at a frequency F_{c}, has a flat spectrum extending from essentially zero to about 2/3 F_{c}. The fact that the spectrum starts at zero frequency extending up to approximately F_{c} requires a very high F_{c} if a wideband system that does not tune to low input frequencies is to be calibrated. Under these conditions the PRN generator's spectrum must extend to frequencies well into the range covered by the instrument to provide an adequate calibration signal for very wide bandwidth systems requiring a very high F_{c} if a typical PRN generator is used. High rate PRN generators are very difficult to design because a large amount of logic is required to implement a PRN generator with a long sequence, and it is difficult to create large sequential logic systems that clock at a high clock frequency. It would be preferable if a limited frequency PRN generator could be modulated onto a carrier at several hundred MHz so that full use of its bandwidth could be made. However this is difficult to accomplish using ordinary analog RF hardware without incurring flatness errors or a cost penalty.

When a PRN sequence is used in operational equipment, cost is often a severe issue. Here it is desired that the cost of implementing an up converted PRN signal be reduced to an absolute minimum.

What is desired is a modulated PRN generator that may be readily accomplished at low cost for all uses while maintaining flatness when used in test equipment.

### BRIEF SUMMARY OF THE INVENTION

Accordingly the present invention provides an up converted PRN generator that logically modulates a pseudo-random sequence onto a carrier using inexpensive digital hardware to avoid using analog hardware of uncertain flatness. A carrier frequency at an integer multiple of a clock signal and the output of a PRN generator clocked by the clock signal are input to an exclusive OR gate to produce an up converted PRN sequence having a flat bandwidth about the carrier frequency that is twice that of a baseband PRN sequence.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a block diagram view of an up converted PRN generator according to the present invention.

### DETAILED DESCRIPTION OF THE INVENTION

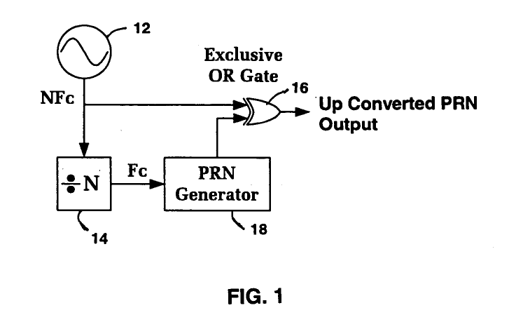

Referring now to FIG. 1 a carrier frequency source 12 provides a carrier signal having a frequency that is an integer multiple N of a clock frequency F_{c}. The carrier signal is input to both a frequency divider 14 to derive the clock frequency from the carrier signal and to an exclusive OR gate 16. A PRN generator 18 is clocked by the clock signal from the frequency divider 14 to provide a pseudo-random sequence that also is input to the exclusive OR gate 16. The output from the exclusive OR gate 16 is an up converted PRN signal that may be used for internal calibration of a measurement instrument. Typical exclusive OR gates operate well above the frequency that the PRN generator 18 reliably operates. The result is that the PRN sequence from the PRN generator 18 is modulated onto a carrier at F_{c}. The PRN sequence spectrum is flat to about 2/3 F_{c} on either side of the carrier, resulting in a flat spectrum having a bandwidth of 4/3 F_{c}. This essentially doubles the bandwidth of the PRN sequence. Therefore better use of available PRN bandwidth is made since it is centered at a carrier frequency well above zero. The cost of this system is minimized by the use of a logic function instead of a circuit using an analog modulator such as a double balanced mixer.

Thus the present invention provides an up converted PRN generator that modulates a PRN sequence logically onto a carrier frequency to double the bandwidth of the PRN response at a frequency well above zero.

1. An up converted PRN generator comprising:
a source of a carrier signal having a frequency well above zero;
a PRN generator clocked by a clock signal derived from the carrier signal to produce a PRN sequence; and
means for logically modulating the carrier signal with the PRN sequence to produce an up converted PRN output signal having a wide bandwidth about the carrier signal frequency at a frequency range well above zero.

2. The up converted PRN generator as recited in claim 1 further comprising means for counting down the carrier signal frequency by an integer to derive the clock signal.

3. The up converted PRN generator as recited in claims 1 or 2 wherein the logically modulating means comprises an exclusive OR gate having the carrier signal and PRN sequence as inputs and providing the up converted PRN output signal as an output.

4. The up converted PRN generator as recited in claims 1 or 2 wherein the up converted PRN output signal is used for calibrating a measurement instrument.

5. The up converted PRN generator as recited in claim 3 wherein the up converted PRN output signal is used for calibrating a measurement instrument.

6. The up converted PRN generator as recited in claim 1 wherein the wide bandwidth comprises a frequency range equal to 4/3 the frequency of the clock signal.

7. A method of generating an up converted PRN sequence comprising the steps of:
generating a carrier signal at a frequency well above zero;
generating a PRN sequence as a function of a clock signal derived from the carrier signal; and
logically modulating the carrier signal with the PRN sequence to produce the up converted PRN sequence having a wide bandwidth about the carrier frequency at a frequency range well above zero.

8. The method as recited in claim 7 further comprising the step of counting down the carrier signal frequency by an integer value to produce the clock signal.

9. The method as recited in claims 7 or 8 wherein the logically modulating step comprises exclusively ORing the carrier signal and the PRN sequence to produce the up converted PRN sequence.

10. The method as recited in claim 7 wherein the wide bandwidth comprises a frequency range equal to 4/3 the frequency of the clock signal.

11. The method as recited in claim 7 further comprising the step of applying the up converted PRN sequence to a measurement instrument as a calibration signal.
